(19) United States
(12) Patent Application Publication
(10) Pub. No.: US 2007/0148297 A1
(43) Pub. Date: Jun. 28, 2007

(54) SURFACE PASTEURIZATION OF BULK AGRICULTRUAL PRODUCTS

(76) Inventors: Laurence D. Bell, Pacific Grove, CA (US); Donald Tragethon, Salinas, CA (US)

Correspondence Address: CHRISTOPHER ALLEN REDING, 106 S. LEWIS, STILLWATER, OK, 74074, US

(21) Appl. No.: 11/428,624

(22) Filed: Jul. 5, 2006

Related U.S. Application Data
(60) Provisional application No. 60/595,572, filed on Jul. 16, 2005.

(51) Int. Cl. A47J 39/00

(52) U.S. Cl. 426/520

(57) ABSTRACT

A method and apparatus for processing bulk agricultural products are provided. The method includes bulk loading agricultural products into a sealable container; and heating the agricultural products to a temperature in a range of about 140-350 degrees ° F. for a period of less than about 10 minutes. The apparatus includes a sealable chamber including at least one door sized to allow bulk produce to be loaded into the chamber. A steam generator has an outlet provided in the chamber sized to provide sufficient steam output to raise the temperature of the chamber loaded with produce to a range of about 140-350 degrees ° F. in a period of less than about 10 minutes.

### PRIORITY CLAIM

The present application claims priority to U.S. Provisional Patent Application Ser. No., entitled, “METHOD AND APPARATUS FOR SURFACE PASTERUIZING FRESH WHOLE AGRICULTURAL COMMODITIES IN BULD CONFIGURATION”, Ser. No. 60/595,572 which was filed on Jul. 16, 2005.

### BACKGROUND

Fresh produce can maintain populations of harmful microorganisms when they arrive at the packing house. Target microorganisms include those that can cause food borne illness such as Listeria, Salmonella and E. Coli. Also targeted are organisms residing on the produce exterior that cause increased rates of spoilage by cross contaminating the internal edible produce during peeling, cutting and further processing.

The bacteria population tends to remain relatively stable, with no significant influence exerted by temperature, total precipitation, or length of the day during harvest.

Since improperly handled food products can serve as a vehicle for the transmission of microorganisms to humans, the elimination of such surface bacteria and pathogenic microbes (which include spoilage organisms) has a tremendous value to the food and health industries.

Several approaches to reducing the number of bacteria on the surface of produce and other foods have been attempted. Common chemical sanitizers, such as chlorine treatments, may be reasonably effective for equipment sanitation, but these are not as effective as thermal treatments for eliminating microorganisms from biological materials such as raw produce. Another approach includes steaming herbs, spices, and root/tuber vegetables under pressure, or in a vacuum. Chemical gases may be used to create an antiseptic environment. Each of these processes tends to be expensive and unreliable, fraught with an abundance of complicated equipment which tends to break down, and produce unpredictable results.

Surface pasteurization has also been used. Traditional thermal surface pasteurization processes usually employ in-line apparatus, usually with a continuous means of conveyance through the heat source, generally requiring singulation of the produce into the apparatus. Singulation for manually loading individual produce into these in-line systems involves higher labor costs compared to the present technology. In-line systems are also subject to restricted throughput as constrained by the dimensions and capacity of the apparatus. In-line systems that cause throughput constraints at the head end of the process cause additional inefficiencies down stream where more labor and equipment is employed.

### SUMMARY

In one aspect, a method of processing bulk agricultural products is provided. The method includes bulk loading agricultural products into a sealable container; and heating the agricultural products to a temperature in a range of about 140-350° F. for a period of less than about 10 minutes. Heating may comprise flushing the chamber with a sufficient quantity of steam to raise the temperature to said range in about one minute. In a further aspect, the method further includes agitating the produce during said step of heating and/or evacuating the chamber prior to heating.

In a further embodiment, a surface pasteurization apparatus is provided. The apparatus includes a sealable chamber including at least one door sized to allow bulk produce to be loaded into the chamber. A steam generator has an outlet provided in the chamber and sized to provide sufficient steam output to raise the temperature of the chamber loaded with produce to a range of about 140-350 degrees ° F. in a period of less than about 10 minutes. Alternative embodiments of the apparatus may include a heat exchanger positioned within the chamber and/or an evacuation pump coupled to the chamber.

The apparatus can be sized to hold a few hundred to many thousands of pounds of produce during a surface pasteurization method. The apparatus includes design features that facilitate a thermal surface pasteurization process comprising initially flushing the chamber (containing the produce to be surface pasteurized) vigorously with a heated fluid or gas (for example steam or hot water) of sufficient volume and heat capacity to achieve about 140-350 degrees ° F. throughout the fully or partially loaded chamber in less than about 10 minutes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a method in accordance with the present technology

FIG. 2a depicts a first surface pasteurization method.

FIG. 2b depicts a second surface pasteurization method.

FIG. 2c depicts a third surface pasteurization method.

FIG. 2d depicts alternative processing which may be used in the method of FIG. 1.

FIG. 3 depicts a first apparatus for use in accordance with the present technology.

FIG. 4 depicts a second embodiment of an apparatus created in accordance with the present technology

FIG. 5 depicts a third apparatus similar to that of FIG. 3 outfitted with a vacuum pump in accordance with the present technology.

### DETAILED DESCRIPTION

Technology for the bulk pasteurization of agricultural items includes a method and apparatus for rapidly heating whole items, such as produces consisting of melons, apples, strawberries, and the like. The present technology significantly enhances the food safety and shelf life of whole and edible portions of fresh produce and vegetables by a uniquely cost effective system for rapidly pasteurizing the surface, rind or peel of bulk quantities of whole fresh produce and vegetables. This technology facilitates the application of a high temperature, short time process designed to kill spoilage and pathogenic microorganisms on the surfaces, or imbedded within the outer surfaces, rind or peel of the produce. This surface pasteurization method is accomplished without “cooking” or materially altering the attributes characteristic of the fresh edible interior of the raw commodity. The process is particularly useful on fresh produce destined for further processing into fresh cut produce products, such as, watermelon, cantaloupe, honeydew, pineapple and citrus. This method and apparatus is also useful for extending the shelf life of whole produce destined for storage prior to further processing or sale.

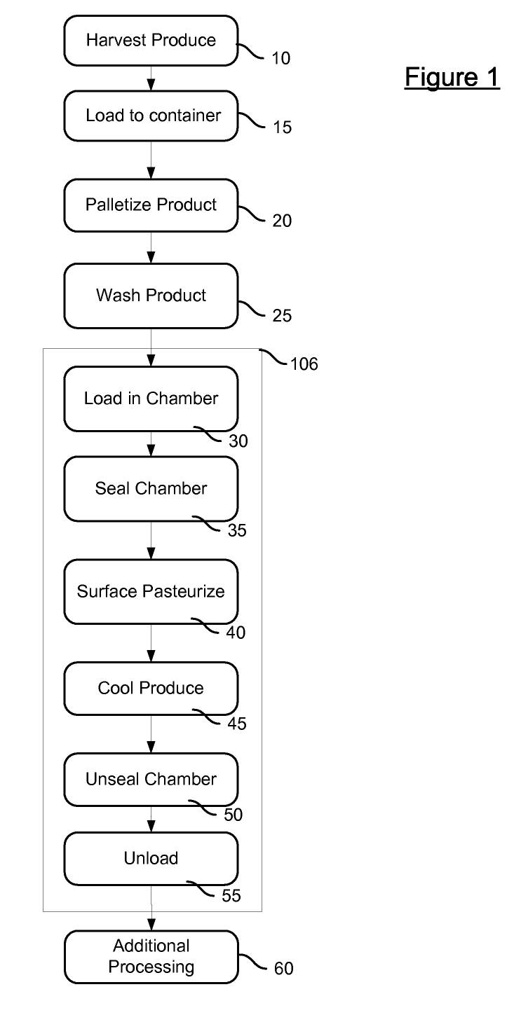

FIG. 1 shows a first embodiment of a process in accordance with the present invention. The technology employs a batch process that can accommodate bulk packaged produce off-line and therefore avoids the labor costs and throughput bottlenecks typical of other in-line surface pasteurization processes and methods.

In general, the process begins when agricultural product is harvested in the growing field at step 10. At step 15, the product may be loaded into a palletizable container. In one aspect, this includes loading produce into a reusable plastic container (RPC), known and used in the produce industry to store and ship fresh produce. The produce may be contained in stacked field containers or a single container. In an alternative aspect, the containers may be designed to permit heat and fluid transfer throughout the container's contents. Alternatively, other means for moving produce in bulk may be provided, and the technology is not limited by the means used to transport or store the produce. At step 20, the produce is optionally palletized (moved to a large pallet movable by mechanical means such as a forklift) for easy bulk transportation. Pallets facilitate moving more bulk produce, but palletization is optional. Optionally, at step 25, an exterior wash of the product may be performed. It should be noted that the washing step may be performed at any point subsequent to harvesting and ultimate shipping or end processing of the product at step 60. Also, precooled or uncooled produce can be processed in the method discussed herein.

Steps 30-55 are performed in a bulk surface pasteurization chamber (SPC) 100. As discussed below, an SPC is designed to rapidly heat the produce for a limited, relatively short period of time to complete pasteurization. This technology may include design features substantially similar in structure and function to existing vacuum cooling chambers in use for cooling fresh produce but modified, as taught herein, to also accomplish rapid heating. In one embodiment, the SPC is a modified apparatus normally employed for vacuum cooling. In such an apparatus, hundreds to thousands of pounds of produce can be handled simultaneously at a fraction of the labor costs necessary for traditional in-line systems.

At step 30, the SPC is loaded, by hand or mechanically assisted means, with one or more containers, RPC's or pallets of produce to be surface pasteurized. It is also possible that produce may be loaded directly into the SPC without containers and stacked within the SPC to facilitate heat transfer around produce surfaces. At step 35, the chamber may be sealed.

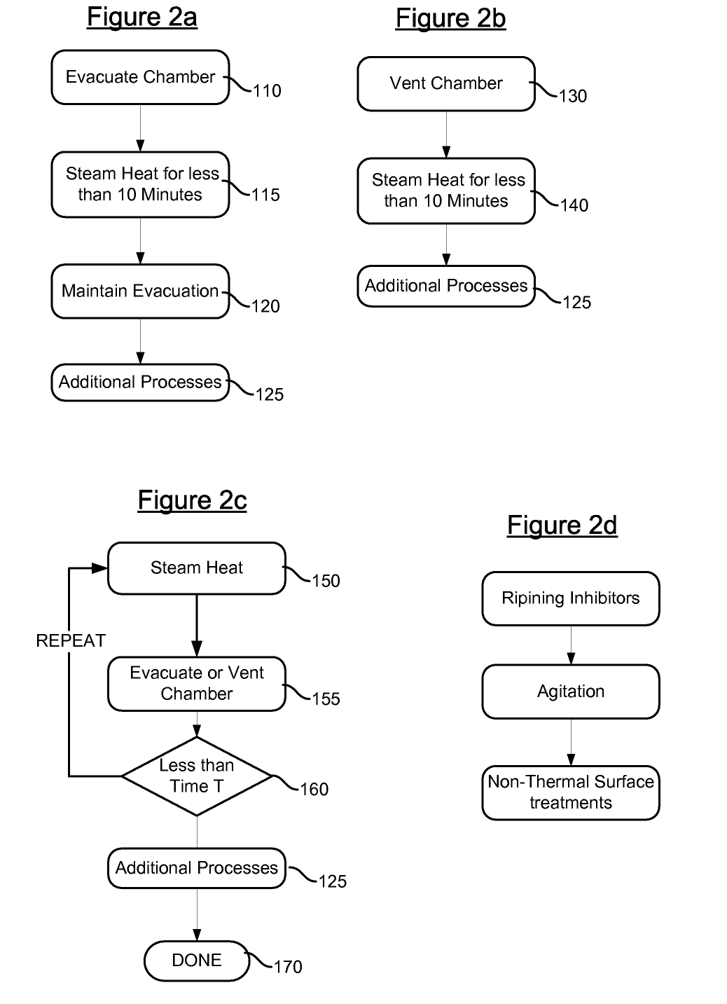

At step 40, a surface pasteurization process is implemented on the product in the chamber. Various alternatives for the surface pasteurization portion of the technology are described below with respect to FIGS. 2a-2d. At step 45, the produce may optionally be subjected to an in-chamber cooling process. Alternatively or additionally, a cooling process may be provided after removal at step 55. After the chamber is unsealed at step 50, the produce may be unloaded at step 55 and subjected to final processing at step 60. Final processing may include washing, cooling, cutting, packaging and/or transporting the produce for shipment and/or sale. Rapid cooling may be employed to stop the pasteurization process and prevent cooking of the produce resulting from latent heat remaining in the produce.

In a unique aspect, the cooling step 45 may be performed immediately after pasteurization by vacuum cooling the thermally processed produce in the chamber. Optionally, a forced air cooling process may be performed in the chamber at step 45. Still further, vacuum and forced air cooling may be combined sequentially in the chamber.

FIGS. 2a-2d illustrate various alternative surface pasteurization processes (step 40) in accordance with the present invention. FIG. 2a illustrates a first process in accordance with the present technology. In this embodiment, the chamber is evacuated to a pressure between 0 and 14 PSIA at step 110 following which a rapid flush of steam is injected into the chamber for a period of less than 10 minutes. Step 115 comprises initially flushing the chamber vigorously with a heated fluid or gas (for example steam or hot water) of sufficient volume and heat capacity to achieve about 140-350 ° F. throughout the chamber, followed by a sustained flow of heated fluid or gas, such as steam, to maintain the temperature selected for less than about 10 minutes. In one embodiment, the process occurs between about 5 seconds and about 300 seconds; in another alternative, the process occurs for between about 5 seconds and about 180 seconds in another alternative between about 5 seconds and 60 seconds. The rapid application of heat or steam in accordance with the teachings herein is sufficient to raise the temperature of the loaded chamber to the desired temperature within a maximum of about 3 minutes or less and hold that temperature.

As discussed below, a chamber apparatus suitable for implementing the process is fitted with a means of continuously generating steam (steam generator) at sufficiently high volume to rapidly satisfy the aforementioned short heating time throughout the entire chamber volume (fully or partially loaded). The primary continuous steam generation means is ideally sized to sustain, for a longer length of time, the chamber temperature within the aforementioned temperature range after the initial injection of steam from the wet accumulator is largely exhausted. In addition to steam, thermal surface pasteurization may employ hot water or other heated gas or fluid under ambient, elevated or reduced pressure conditions, depending on the most economical and functional parameters for meeting the aforementioned temperatures and times to surface pasteurize agricultural commodities.

At step 120, optionally, a chamber vacuum may be maintained prior to the flushing process of step 115. Vacuum applied prior to and/or during heating may be employed to accelerate steam distribution and heat transfer throughout the chamber and into and between materials to be surface pasteurized. The optional application of vacuum after heating can effect rapid cooling of the heated (pasteurized) surface of produces or vegetables. Many commodities would not normally be compatible with vacuum cooling (due primarily to lack of sufficient surface area). Examples would include melons, pineapple and citrus. However, because surface pasteurization significantly heats only the commodity surface, post pasteurization vacuum cooling need only remove that heat from the surface for the purposes of this technology. Alternatively, not rapidly cooling thermally treated produce upon completion of the active thermal process allows latent heat from the process to equilibrate around all produce surfaces thereby continuing the pasteurization process even after removal from the chamber. In one embodiment, a temperature range of 140-212° F. is suitable for a non-post cooled process.

Optionally, additional processing may be included within the pasteurization step 40, as illustrated in FIG. 2d. These may include one or more of: using ripening inhibitors before during or after step 115; agitating or tumbling the produce during step 115; and/or applying non-thermal surface pasteurization treatments before, during or after step 115.

For produce that might ripen at undesirable rates during post SPC storage, due (at least in part) to the application of a thermal process, ripening inhibitors may be introduced into the chamber prior to discharge or applied before, during or after pasteurization. Inhibitors would include 1-methycyclopropene (1-MCP) and similar compounds, carbon dioxide and reduced oxygen. Alternatively, for produce that is desired to ripen faster and more uniformly, ripening accelerators may be introduced into the chamber prior to discharge (or applied before, during or after pasteurization) to cause more rapid (desirable) produce ripening. Ripening accelerators include ethylene and related agents.

In addition, physically agitating or rotating the chamber or the loaded containers inside the chamber will effect tumbling or movement of the materials in close contact, improving the application of heat to all surfaces of the produce.

Non-thermal surface sanitation treatments include gaseous ozone or other biocides, introduced into an SPC and retained for times and at temperatures and pressures necessary for optimal surface pasteurization.

A second alternative thermal surface pasteurization process is shown at FIG. 2B. In this embodiment, at step 130 the chamber is vented rather than evacuated and a rapid flush step process 140 (equivalent to step 115) is performed. As in the process of FIG. 2a, additional processes 125 (FIG. 2d) may be employed in conjunction with this alternative. For more delicate fruits, step 140 (or step 115) is performed in a range of about 140° F. to about 212° F. throughout the chamber and held for up to about 10 minutes. In one embodiment, the process occurs at about 170° F. to 200° F. for about 6 minutes, in another, at about 180° F. to 200° F. for about 5 minutes and less for more delicate commodities.

A third alternative chamber pasteurization process is illustrated in FIG. 2c, wherein a chamber is “pressure bounced” by cycling the steam and venting or evacuation. Steam may be injected at step 150 and the chamber repeatedly evacuated or vented at step 155 until a time T (evaluated at step 160 over any number of intervals) is reached, at which time the process ceases at step 170. Additional processes 125 described above with respect to FIG. 2d may be employed before, during or after pressure cycling.

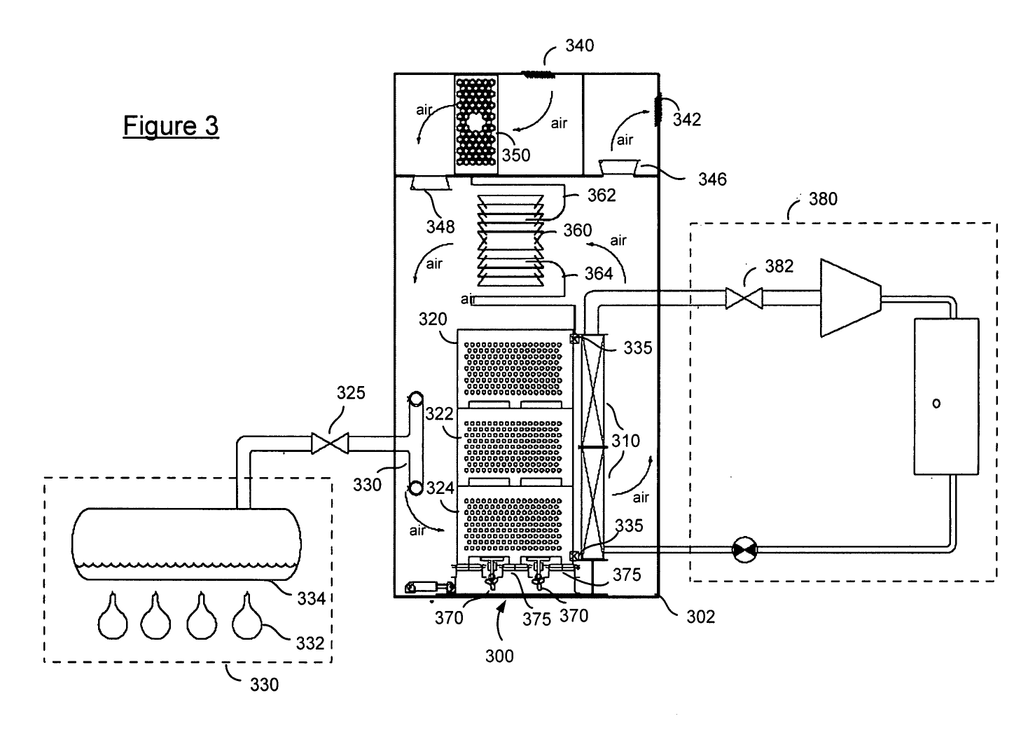

An apparatus suitable for implementing the processes discussed above is shown in FIG. 3. The apparatus of FIG. 3 may be utilized for forced air cooling processes on lower temperature surface pasteurization processes, such as those at temperatures below about 212° F. The apparatus is designed to introduce steam as rapidly as possible to reach 140° F. to about 212° F. throughout the chamber in about 3 minutes or less and to hold a temperature of 140° F. to 212° F. for up to about 10 minutes. In one embodiment, the process occurs at about 170° F. to 200° F. for about 6 minutes, in another, at about 180° F. to 200° F. for about 5 minutes and less for more delicate commodities. During this heating time, the produce would be agitated or tumbled, preferably by rotating the RPC's and/or the entire pallet of RPC's.

An exemplary SPC 300 includes a chamber 302 having sufficient capacity to hold at least one and in other embodiments many pallets 320, 322, 324 of produce. Other chamber volumes are contemplated, ranging from a minimum volume sufficient to handle one RPC to several RPCs to several pallets (sized 40″×48″×72″ each) within the chamber. In one embodiment, the chamber is designed such that surface pasteurized produce is isolated from incoming (unpasteurized) produce or other sources of post-pasteurization cross contamination by virtue of being discharged into a clean room or environment. In this case, one end of chamber 302 may be used for incoming produce and a second end used for pasteurized produce. Discharge to a clean room may be accomplished by having a discharge door on one end of the chamber, separate from the loading door on the other end such that the pasteurized produce is unloaded into the cleaner environment before the loading door is opened to load the next batch of unpasteurized produce into the chamber. Alternatively, pasteurized produce could be unloaded into a mobile (sanitary container) after a pasteurization cycle, or the chamber could be rotated such that it discharges into a clean room through the same door used for loading the unpasteurized produce. Another alternative includes the use of pallet covers or bags placed over the pallets of surface pasteurized produce to minimize cross contamination after removal from an SPC. Upon completion of the surface pasteurization process the produce may be discharged to ambient temperature, refrigerated holding or transport environments or immediately processed or sold as a whole produce commodity. Alternatively, one point of loading and unloading may be provided.

A steam generator 330 includes a heat source 332 and generation tank 334 sized to have sufficient capacity to provide initial high volume of steam within a very short period of time. Optionally, the steam generator may include a wet accumulator surge tank or other supplemental source of steam or heated fluid source. In one embodiment, a wet accumulator that contains a mixture of steam and saturated water at a high temperature and pressure is used. Steam is released from the accumulator through a steam valve 325 into the SPC chamber. As steam is released, pressure drops in the accumulator and saturated water flashes to steam producing additional steam. An SPC accumulator may be sized to deliver the aforementioned temperatures and times throughout the chamber void volume. Flashing steam from the wet accumulator tank is distributed throughout the SPC by opening steam valve 325 plumbed to appropriately sized and positioned steam headers 330 inside the chamber. In one embodiment, this may comprise 1.5 inch galvanized pipe with teeth fitted along the length of the pip in the chamber to allow stem to be distributed throughout the chamber. The primary continuous steam generation means 330 is ideally sized to sustain, for a longer length of time, the chamber temperature within the aforementioned temperature range after the initial injection of steam from any wet accumulator is largely exhausted.

A heat exchanger 310 which may comprise refrigeration coils may be provided in the chamber. Given the amount of produce in the chamber, cooling of the produce will extract excess liquid from the produce. The heat exchanger may be maintained at a lower temperature than the water vapor to condense the vapor away from the produce. Heat exchanger 310 is coupled to a control valve 382 and a heat rejection means or condenser 380.

Venting may be provided by a fresh air inlet 340 allowing air to circulate in though an air filter 350 and a high to low pressure control valve 348. A forced air fan 360 is provided to circulate air in the direction of arrows (air). One side of the fan includes a tapered inlet 362/364. A low to high pressure vent 346 allows venting of the chamber to an external vent 342 to purge any vapor in the chamber to the external environment.

Additionally, the chamber may include a conveyor system 375 on which containerized or palletized produce may be moved from one end of the chamber to the other once loaded into the chamber. A container or pallet oscillation or rotation mechanism 370 may be provided to agitate or tumble the containerized or palletized produce at a sufficient rate to allow movement of the produce within the containers to facilitate heating, but at an amount of movement insufficient to damage the produce in containers 320, 322, 324.

As noted above, the SPC 300 may or may not include vacuum cooling capability. The SPC may be equipped with vacuum cooling capability providing for the application of vacuum prior to, during and after the thermal surface sanitation process. Alternatively, surface pasteurized produce can be transported from the SPC to a separate vacuum-cooling chamber or other cooling means or alternatively discharged to further processing or storage in a refrigerated or non-refrigerated environment with no further cooling. Because the produce has been surface sanitized, decay of the produce exterior is inhibited longer than would otherwise be possible, even without active cooling or refrigerated storage.

A vapor separation means 335 comprises a “bumper” gasket interface between containers 320, 322, 324 and the heat exchanger 310. The vapor (steam) pressure is greater in the area that houses 320, 322, 324 and lower to the right of 310 as illustrated. The means is a cushion that follows the perimeter of the 310 face. Containers 320, 322, 324 are pressed up against the means providing a seal by the gentle squashing of the cushion. With the cushion squashed, the vapor (energy) is forced to interface with the product to be sterilized. In the Figure, the square with an “X” in it represents the cross-section of the cushion with boxed x's representing two cross sections of one contiguous peripheral gasketing cushion.

The technology facilitates a lower cost supply chain where produce can be harvested directly into containers that facilitate washing and precooling. In addition, transport to and through the SPC and beyond is made more sanitary, with handling of the surface pasteurized produce downstream requiring no further loading, unloading or singulation of the produce from the containers until final processing or sale. Further contributing to the cost effectiveness of this process is the concurrent sanitation of the returnable field containers during the surface pasteurization cycle, facilitating container reuse with no additional costly sanitation steps. Other potential cost advantages offered by this technology relative to in-line systems for surface pasteurization include the option of performing the surface pasteurization process very near field harvest locations in mobile SPC's that can be relocated as seasonal growing and harvesting locations change. The surface pasteurized commodities can then be transported to outlying further processing or distribution centers.

This technology may preclude the need for active cooling of the surface pasteurized whole unprocessed commodity prior to further processing or storage. Surface pasteurized produce can be accumulated and inventoried (stored) for many hours or days (even without cooling) prior to delivery to further processing lines or distribution in commodity form. For further processed produce or vegetables, cooling, if necessary, can be applied more economically to the finished product.

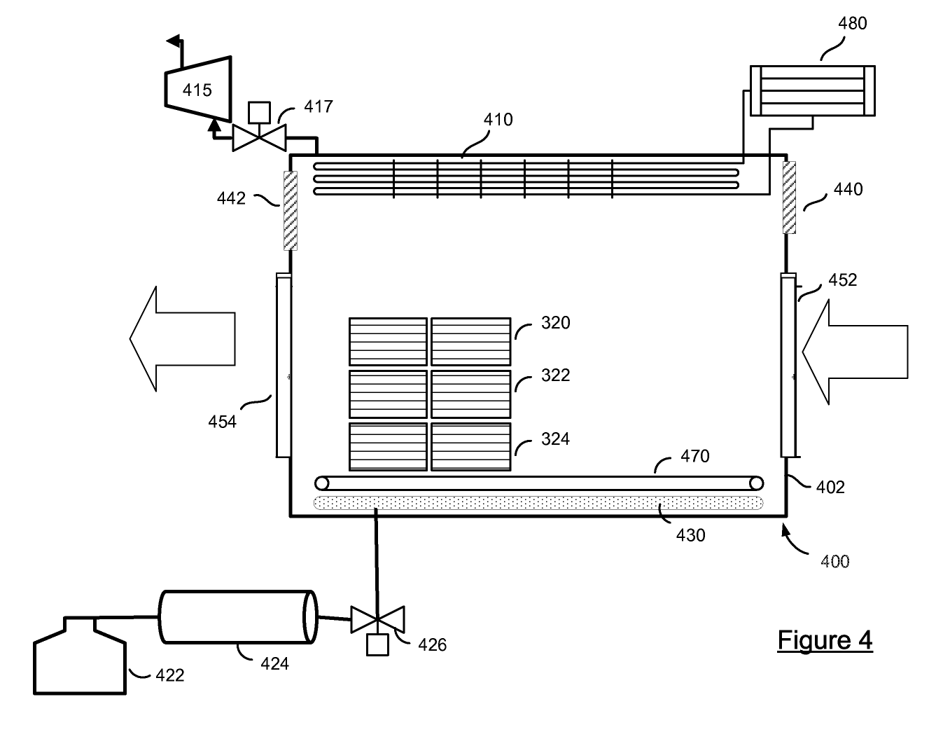

FIG. 4 is an alternative apparatus suitable for implementing the processes discussed above. The apparatus of FIG. 4 illustrates a chamber which may be created from a modified vacuum cooling chamber such as that commercially used by Western Pre-cooling Systems, Fremont, Calif.

A second exemplary SPC 400 includes a chamber 402 having sufficient capacity to hold at least one and in other embodiments many containers 320, 322, 324 of produce. This chamber facilitates isolation by a load door 452 used for incoming produce and a second door 454 used for pasteurized produce. Discharge to a clean room may be accomplished by having a discharge door open to the clean room. A conveyor system 475 moves containerized or palletized produce from one end of the chamber to the other once loaded into the chamber

A steam generator 420 is coupled to an accumulator 424 sized to have sufficient capacity to provide initial high volume of steam within a very short period of time. The wet accumulator surge tank provides a mixture of steam and saturated water at a high temperature and pressure is used. Steam is released from the accumulator through a steam valve 426 into the SPC chamber 402. As steam is released, pressure drops in the accumulator and saturated water flashes to steam producing additional steam. An SPC accumulator may be sized to deliver the aforementioned temperatures and times throughout the chamber void volume. Flashing steam from the wet accumulator tank is distributed throughout the SPC by opening steam valve 426 plumbed to appropriately sized and positioned steam headers 430 inside the chamber. A vacuum pump 415 may be provided to allow for evacuation of the chamber 402 in accordance with the foregoing processes.

A heat exchanger 410 which may comprise refrigeration coils may be provided in the chamber. Heat exchanger 410 is coupled to condenser 480. Vents 440 and 442 may be provided to allow air to circulate though the chamber.

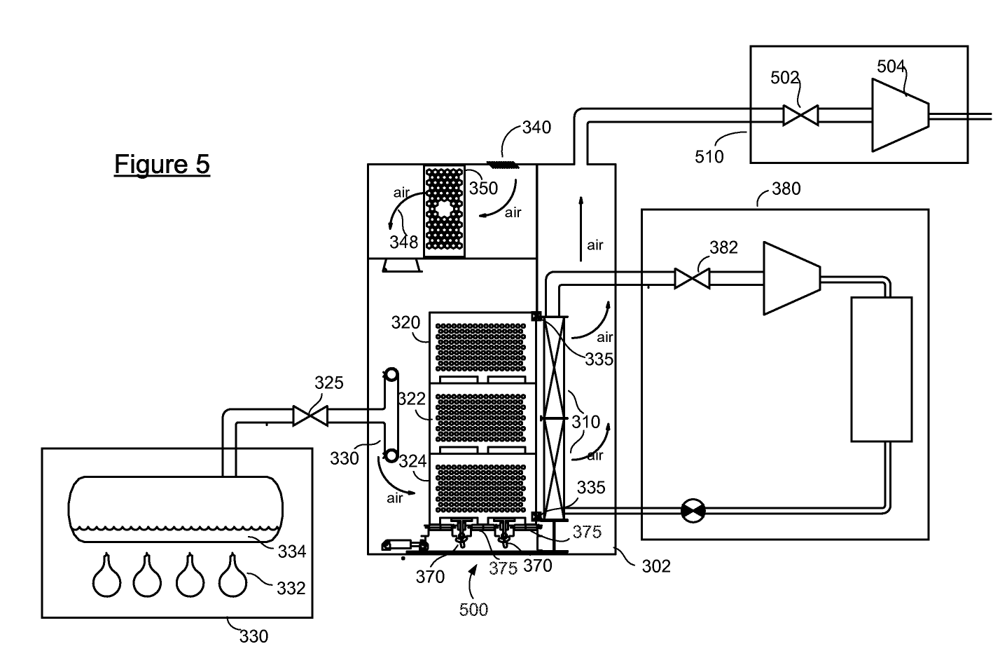

FIG. 5 shows another alternative apparatus suitable for use in accordance with the present technology. FIG. 5 shows a chamber 500 having features equivalent to those of the apparatus 300 depicted in FIG. 3 such that like reference numerals indicate like parts shown and described with respect to FIG. 3. Chamber 500 is formed to with stand greater vacuum pressure than chamber 300 and is fitted with an evacuation pump 510 including a control valve 502 and pump 504, allowing the chamber to be evacuated prior to steam input or to implement a vacuum cooling process after the pasteurization process. Airflow within the chamber is again indicated by arrows (Air).

Although numerous features are included in the apparatus of FIGS. 3 and, not all such features need be included to implement the above processes. For example, the SPC need not include an evacuation pump and venting, but may include one or the other.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method of processing bulk agricultural products, comprising:
bulk loading agricultural products into a sealable container; and
heating the agricultural products to a temperature in a range of about 140-350 degrees ° F. for a period of less than about 10 minutes.

2. The method of claim 1 wherein the step of bulk loading comprises loading agricultural product onto a pallet and loading the pallet into the sealable container.

3. The method of claim 2 wherein the step of loading comprises loading agricultural product into reusable containers and loading the containers onto the pallet.

4. The method of claim 1 wherein the step of heating comprises flushing the chamber with a sufficient quantity of steam to raise the temperature to said range in less than about two minutes.

5. The method of claim 1 wherein the step of heating occurs for between about 5 seconds and about 300 seconds.

6. The method of claim 1 wherein the step of heating occurs for between about 5 seconds and about 180 seconds.

7. The method of claim 1 wherein the step of heating occurs for between about 5 seconds and 60 seconds.

8. The method of claim 1 wherein the method further includes agitating the produce during said step of heating.

9. The method of claim 1 wherein the method further includes tumbling the produce during said step of heating by rotating containers holding the produce.

10. The method of claim 1 further including the step of evacuating the chamber prior to said step of heating.

11. The method of claim 10 further including cycling said steps of heating and evacuating repeatedly.

12. The method of claim 1 further including applying forced air circulation around said produce during said step of heating.

13. The method of claim 1 further including applying ripening inhibitors after said loading step.

14. The method of claim 1 further including applying non-thermal surface pasteurization treatments after said loading step.

15. The method of claim 1 further including the step of venting the chamber during said step of heating.

16. The method of claim 1 further including cycling said steps of heating and venting repeatedly.

17. The method of claim 1 further including the step of evacuating the chamber to a vacuum following said step of heating.

18. The method of claim 17 wherein the step of evacuating the chamber includes evacuating to a vacuum sufficient to cool the produce in the chamber to ambient temperature or below.

19. The method of claim 1 further including the step providing forced air cooling of the chamber following said step of heating.

20. The method of claim 1 further including the step of evacuating the chamber to a vacuum following said step of heating and providing forced air cooling of the chamber following said step of evacuating.

21. A surface pasteurization apparatus, comprising:
a sealable chamber including at least one door sized to allow bulk produce to be loaded into the chamber;
a steam generator having an outlet provided in the chamber, the generator providing sufficient steam output to raise the temperature of the chamber loaded with produce to a range of about 140-350 degrees ° F. in a period of less than about 10 minutes.

22. The apparatus of claim 21 wherein the generator has an output sufficient to raise the temperature of the chamber loaded with produce to a range of about 140-350 degrees ° F. in a period of less than 180 seconds.

23. The apparatus of claim 21 wherein the generator has an output sufficient to raise the temperature of the chamber loaded with produce to a range of about 140-350 degrees ° F. in a period of less than about 60 seconds.

24. The apparatus of claim 21 further including an ambient vent.

25. The apparatus of claim 24 wherein the ambient vent includes an inlet vent and an outlet vent.

26. The apparatus of claim 24 wherein the ambient vent includes a selectable control to vent the chamber.

27. The apparatus of claim 21 further including a heat exchanger positioned within the chamber.

28. The apparatus of claim 21 further including a evacuation pump coupled to the chamber.

29. The apparatus of claim 21 further including a forced air circulation apparatus positioned within the chamber.

30. The apparatus of claim 21 further including an agitation structure positioned to agitate bulk produced loaded in the chamber.

31. The apparatus of claim 21 further including a rotation structure position to rotate the produce in the chamber.

32. The apparatus of claim 31 wherein the rotation structure includes a pallet support.

33. The apparatus of claim 21 wherein the chamber further includes a first sealable input door and a second sealable output door.

34. The apparatus of claim 33 further including a conveyor positioned between the input door and the output door, the conveyor capable of transporting bulk produce in bulk containers.
